(19) United States
(12) Patent Application Publication
(10) Pub. No.: US 2012/0210648 A1
(43) Pub. Date: Aug. 23, 2012

(54) Protective assembly for door hinge

(76) Inventor: Cheng-Yi Yang, Taichung (TW)

(21) Appl. No.: 13/281,422

(22) Filed: Oct. 25, 2011

(30) Foreign Application Priority Data
Feb. 22, 2011 (TW) 100203181

(51) Int. Cl. E06B 7/36

(52) U.S. Cl. 49/383

(57) ABSTRACT

A protective assembly is provided with a flexible, extensible, longitudinal bellows including folding units each having a cross-section of “n”, and two joining members at both sides respectively; two elongated metal brackets each including a longitudinal first groove of rectangular cross-section on one surface distal the bellows and a longitudinal second groove the other surface proximate the bellows; and two fastening members each fitted in the first grooves to secure the bracket to an inner surface of either a door frame or a door. The joining members are fitted and fastened in the second grooves respectively so as to cover a gap between the door frame and the door.

### BACKGROUND OF THE INVENTION

1. Field of the Invention

The invention relates to door hinges and more particularly to a protective assembly having a bellows mounted adjacent to a hinge of a door and a door frame so as to prevent finger(s) of an individual from being hurt when closing the door.

2. Description of Related Art

A conventional door is connected to a door frame by a hinge for swinging movement on a pivot axis of the hinge from a closed position to an open position with respect to an opening defined by the door frame. It is understood that there is a gap between the door and the door frame. Thus, finger(s) of an individual may be hurt accidentally by inserting into the gap when closing the door if sufficient care is not taken. Thus, the need for improvement still exists.

### SUMMARY OF THE INVENTION

It is therefore one object of the invention to provide a protective assembly comprising a flexible, extensible, longitudinal bellows including a plurality of folding units each having a cross-section of “n”, and two joining members at both sides respectively; two elongated metal brackets each including a longitudinal first groove of rectangular cross-section on one surface distal the bellows and a longitudinal second groove the other surface proximate the bellows; and two fastening members each fitted in the first grooves to secure the bracket to an inner surface of either a door frame or a door, wherein the joining members are fitted and fastened in the second grooves respectively so as to cover a gap between the door frame and the door.

The above and other objects, features and advantages of the invention will become apparent from the following detailed description taken with the accompanying drawings.

### BRIEF DESCRIPTION OF THE DRAWINGS

FIG. 1 is a perspective view of a bellows, as a constituent of a protective assembly, mounted adjacent to a hinge of a door and a door frame according to the invention where the door is closed;

FIG. 2 is a cross sectional view of FIG. 1 showing a further protective cover of the protective assembly;

FIG. 3 is an enlarged view of the left portion of FIG. 2;

FIG. 4 is a detailed view of a circle A in FIG. 3; and

FIG. 5 is a view similar to FIG. 2 showing the door being open.

### DETAILED DESCRIPTION OF THE INVENTION

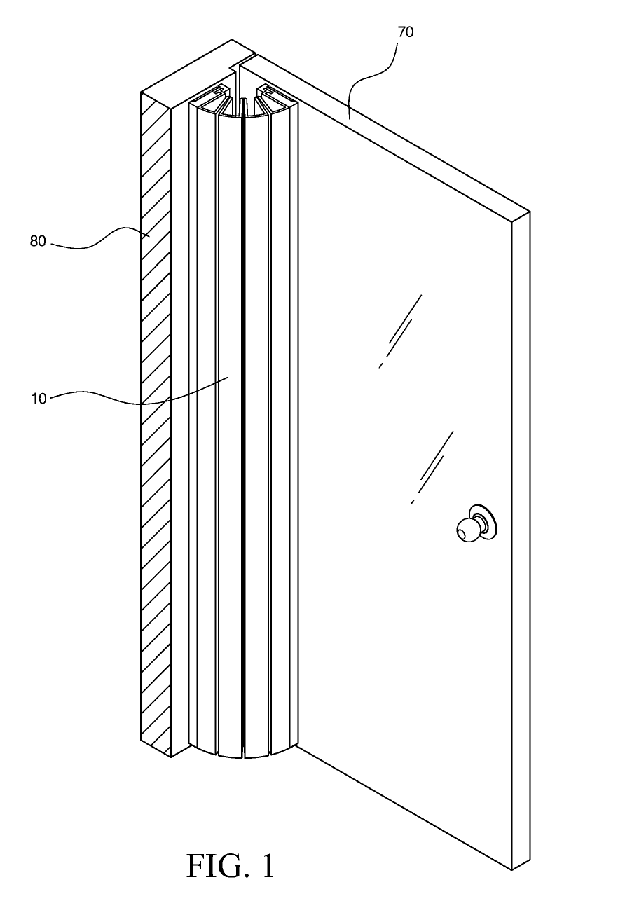

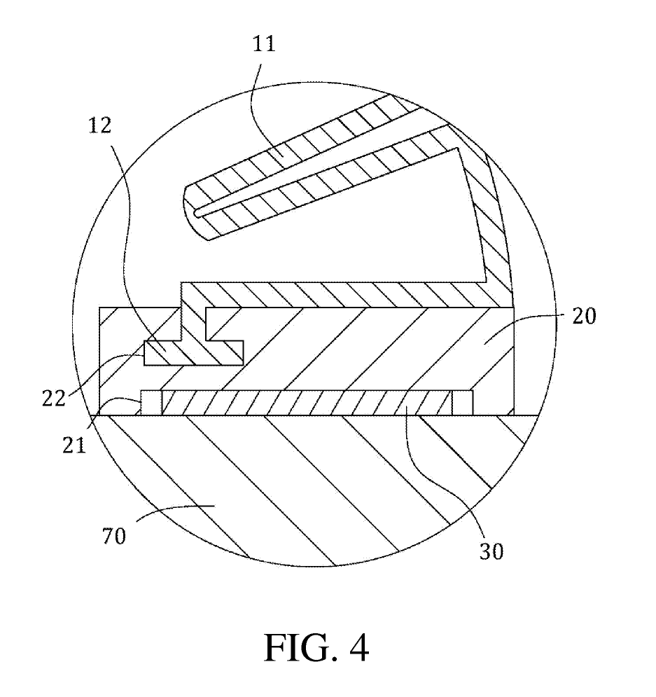

Referring to FIGS. 1 to 5, a protective assembly in accordance with the invention is shown. The protective assembly comprises the following elements as discussed in detail below.

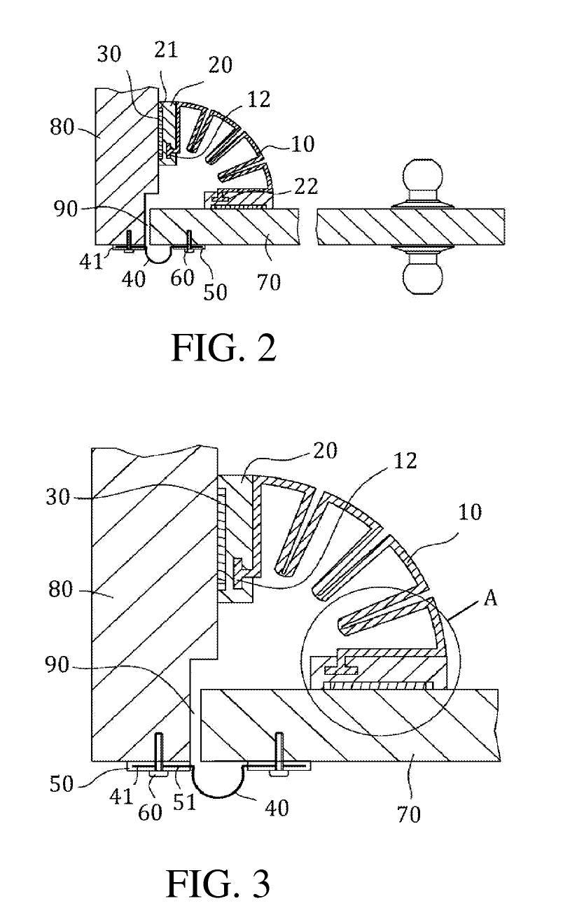

A longitudinal, folding bellows 10 is made of flexible, extensible plastic and is an integral member. Each of its connected folding units 11 of the bellows 10 has a section of “n”. Further, a connecting portion of any two adjacent folding units 11 of the bellows 10 has a thickness less than that of the folding unit 11 thereof. As shown in FIGS. 2 and 3, either side of the bellows 10 is formed as a joining member 12 of T cross-section.

Two elongated metal brackets 20 are provided. The bracket 20 comprises a longitudinal first groove 21 of rectangular cross-section on one surface distal the bellows 10 and a longitudinal second groove 22 of T cross-section on the other surface proximate the bellows 10. A fastening member (e.g., adhesive strip in the embodiment or screw or nail as envisaged by the invention) 30 is fitted in each of the first grooves 21 and secured to either a door frame 80 or a door 70. Further, the joining members 12 are fitted and fastened in the second grooves 22. As a result, the bellows 10 is mounted on inner surfaces of both the door 70 and the door frame 80.

A gap 90 exists between the door frame 80 and the door 70. A longitudinal, hinged protective cover 40 of substantially half circular cross-section is made of flexible, extensible plastic and is an integral member. The protective cover 40 comprises two side wings 41. Two mounting members 50 of “n” cross-section each have a longitudinal trough 51 of rectangular cross-section. The side wings 41 are fitted in the troughs 51 respectively. Further, Two fasteners (e.g., screws) 60 each are driven through the mounting member 50 and the side wing 41 into the door frame 80 and the door 70 respectively. As such, the protective cover 40 is mounted on outer surfaces of both the door 70 and the door frame 80.

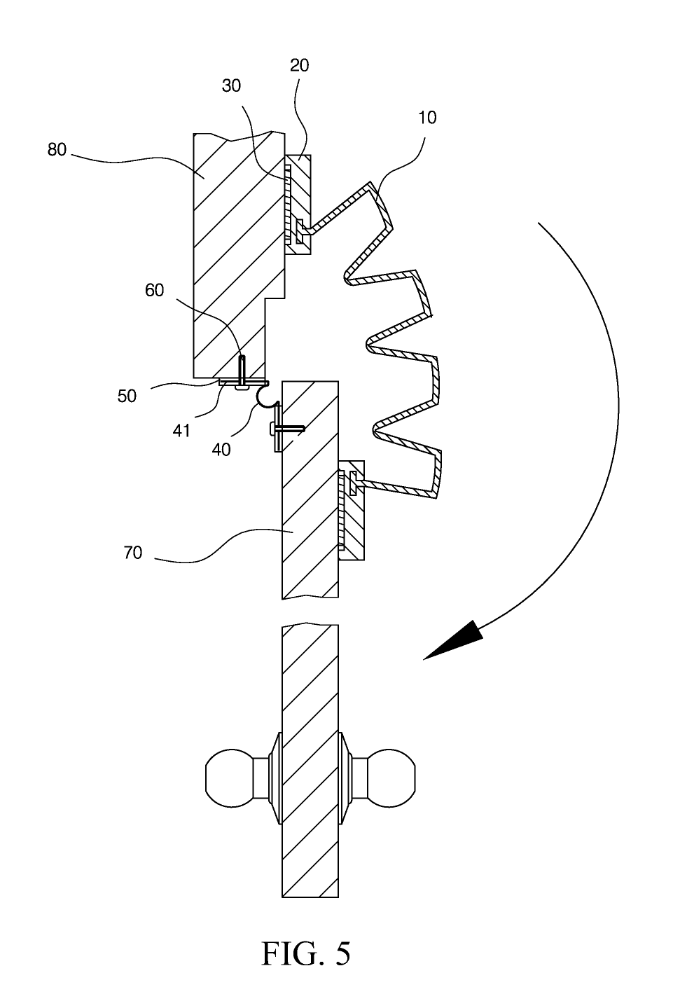

It is envisaged by the invention that the gap 90 is covered by both the bellows 10 and the protective cover 40 so that finger(s) of an individual is prevented from being hurt accidentally by inserting into the gap 90 when closing the door 70 (see FIG. 2). The flexible, extensible nature of the bellows 10 enables it to either expand when opening door 70 (see FIG. 5) or compress when closing the door (see FIG. 2) easily. Moreover, its construction is simple. Further, its installation is easy and quick due to threaded fastening (i.e., protective cover 40) and adhesive fastening (i.e., fastening member 30 being adhesive strip).

While the invention has been described in terms of preferred embodiments, those skilled in the art will recognize that the invention can be practiced with modifications within the spirit and scope of the appended claims.

What is claimed is:

1. A protective assembly comprising:
a flexible, extensible, longitudinal bellows including a plurality of folding units each having a cross-section of “n”, and two joining members at both sides respectively;
two elongated metal brackets each including a longitudinal first groove of rectangular cross-section on one surface distal the bellows and a longitudinal second groove the other surface proximate the bellows; and
two fastening members each fitted in the first grooves to secure the bracket to an inner surface of either a door frame or a door,
wherein the joining members are fitted and fastened in the second grooves respectively so as to cover a gap between the door frame and the door.

2. The protective assembly of claim 1, wherein the second grooves are of T cross-section.

3. The protective assembly of claim 1, wherein a connecting portion of any two adjacent folding units of the bellows has a thickness less than that of the folding unit thereof.

4. The protective assembly of claim 1, wherein the fastening members are adhesive strips, screws or nails.

5. The protective assembly of claim 1, further comprising a longitudinal, hinged protective cover disposed on outer surfaces of both the door and the door frame and spaced from the bellows.

6. The protective assembly of claim 5, wherein the protective cover has a half circular cross-section and is formed of flexible, extensible plastic.

7. The protective assembly of claim 5, further comprising two mounting members of “n” cross-section, each mounting member having a longitudinal trough, and wherein the protective cover includes two side wings fitted in the troughs respectively so that a plurality of fasteners each can be driven through the mounting member and the side wing into either the door frame or the door for fastening.

8. The protective assembly of claim 5, further comprising two mounting members of “n” cross-section, each mounting member having a longitudinal trough of rectangular cross-section, and wherein the protective cover includes two side wings fitted in the troughs respectively so that a plurality of fasteners each can be driven through the mounting member and the side wing into either the door frame or the door for fastening.
